(19) United States
(12) Patent Application Publication
(10) Pub. No.: US 2006/0027437 A1
(43) Pub. Date: Feb. 9, 2006

(54) Compact unit for means of validation and payment/return of coins

(75) Inventor: Felix Guindulain Vidondo, Peralta (Navarra) (ES)

Correspondence Address: KLAUBER & JACKSON, 411 HACKENSACK AVENUE, HACKENSACK, NJ, 07601, US

(73) Assignee: JOFEMAR, S.A.

(21) Appl. No.: 11/197,387

(22) Filed: Aug. 4, 2005

(30) Foreign Application Priority Data
Aug. 5, 2004 (ES) P200401953

(51) Int. Cl. G07F 9/10

(52) U.S. Cl. 194/350

(57) ABSTRACT

Compact unit for means of validation and payment/return of coins, of utility for its incorporation in automatic dispensing machines and especially in recreational prize machines, the compact unit (1) comprising a support casing (2) inside of which are fitted conveying means (3) for the coins (4) destined for return and payments, a selector (5) is associated to said casing (2) to which the coins gain access via a duct (6), a coin sorting separator (7) beneath the selector (5), at least one “Hopper” type paying bin (8), the exit mouth of the coins from the paying bin (8) being connected to a duct (9) made in the interior of the support casing (2), this duct (9) leading to the conveying means (3) the coins to be returned/paid which will convey them to the collection box, along with a series of guide ducts for the coins.

### OBJECT OF THE INVENTION

As stated in the title of this specification, the following invention refers to a Compact unit for means of validation and payment/return of coins, in such a way that said compact unit is of utility for its incorporation in automatic dispensing machines and especially in recreational prize machines, such that the compact unit comprises a support casing inside of which are fitted conveying means for the coins destined for return and payments, to which casing is fitted a coin selector associated with a coin sorting separator, at least one “Hopper” type paying bin with the corresponding guide ducts for the coins and some means of conveying the coins destined for payment.

In this way, all the means necessary for the selection or validation of the coins for their storage and for their conveying, along with their return or payment in their conduction to the collection box, form a compact unit, facilitating the fitting thereof in the factory along with their fitting in the automatic machine and possible later replacement.

### FIELD OF APPLICATION

This specification describes a Compact unit for means of validation and payment/return of coins, in such a way that said compact unit is of application for being incorporated into automatic dispensing machines which operate by means of the introduction of coins and/or bank-notes, being of special application in recreational prize machines.

### BACKGROUND OF THE INVENTION

Conventionally, the different mechanisms necessary for the validation/selection of coins, and for the return/payment thereof, which are incorporated in automatic machines operated by means of the introduction of coins and/or bank-notes, whether they are dispensing machines for all kinds of products or recreational prize machines, consist of means which have to be fitted independently being coupled together for their correct functioning.

In this way, the fitting operation is made difficult due to the fact that the different mechanisms have to be fitted and coupled inside the body of the machine given that one of the desired requisites is that they should take up as little room as possible in order to optimise the available space.

Also, it has to be taken into account the nowadays great existence of different types and models of automatic machines which function by means of the introduction of coins, whether they are dispensing machines of a wide range of products or recreational machines, and the more personalised they are the greater the complexity of their manufacture, with all the drawbacks that this entails.

Moreover, we can consider Invention Patent P200201240 issued in favour of the same holder of this application, in which a “coin conveyor and elevator system for recreational prize machines” is described, whose conveying system for the product consists of a pair of endless elastic conveyor belts guided by some cylindrical bodies, which can be assisted by freely rotating rods, with one of the cylindrical bodies of each of the elastic belts acting as a driver element in order to transmit independent movement to them.

So, a first endless elastic conveyor belt is fitted defining a first horizontal section beneath the different product storage bins and a second section in a vertical position along a side of the machine, while the second elastic conveyor belt is fitted in a position attached to the vertical side section of the first elastic belt, with a deviator element being arranged between the vertical section of the first elastic belt and the second endless elastic conveyor belt which deviates the product towards the duct leading to the collection box, the deviator element being arranged in an inclined position in relation to its upper part, this technology forming part of the elevator conveying means for coins destined for payments and return used in the design of the compact unit.

### DESCRIPTION OF THE INVENTION

This invention refers to a Compact unit for means of validation and payment/return of coins, in such a way that said compact unit is of utility for its incorporation in automatic dispensing machines and especially in recreational prize machines, such that the compact unit comprises a support casing inside of which are fitted conveying means for the coins destined for return and payments, associated with said casing there is a selector to which the coins gain access via an inlet duct, a coin sorting separator beneath the selector, at least one “Hopper” type paying bin, the exit mouth for the coins from the paying bin being connected to a duct made inside the support casing, this duct leading to the means of conveying the coins to be returned/paid which will convey them towards the collection box, along with a series of guide ducts for the coins.

In this way, the compact unit that is described is of special utility in recreational prize machines, given that all the means for the validation of coins, return, sorting, provisional storage in “Hopper” type paying bins and payment are incorporated defining a unitary whole.

Likewise, the support casing holds a reducer motor for driving the elevator conveying means for the return/payment coins defined by a pair of belts and a sensor of rotation of said belts.

The coins rejected by the selector, namely, those which are not accepted as “good”, are led from the selector itself to the duct made in the interior of the support casing, this duct leading to the means of conveying the coins to be returned/paid which will convey them to the collection box.

Moreover, the coins validated by the selector as acceptable can be led from the corresponding outlet from the sorting separator via respective ducts to the different “Hopper” type paying bins, which are fitted in the actual support casing.

Likewise, the coins validated by the selector as acceptable can be led from the corresponding outlet of the sorting separator via the respective duct to the storage deposit, with the final storage deposit being located beneath the support casing.

In order to complement the description that is going to be made forthwith, and with the aim of aiding a better understanding of the characteristics of the invention, this specification is accompanied by a set of plans whose figures represent, in a way that is illustrative rather than limiting, the most characteristic details of the invention.

### BRIEF DESCRIPTION OF THE DESIGNS

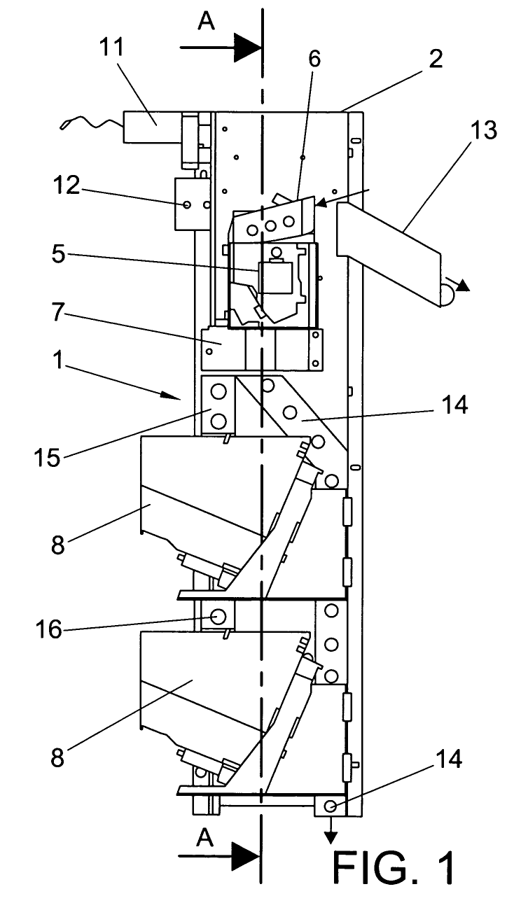

FIG. 1. Shows an elevation view of a Compact unit for means of validation and payment/return of coins, being able to observe the entrance for the coins into the selector, a sorting separator beneath it, guide ducts for the coins, a pair of “Hopper” type paying bins and the exit mouth for the coins to the collection box.

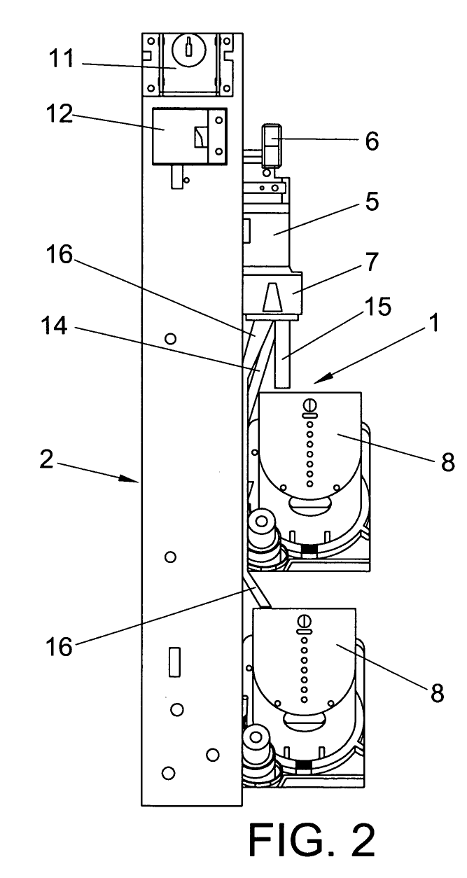

FIG. 2. Shows an elevation view of the compact unit of the previous figure according to a view at 90°, being able to observe the entrance mouth for the coins into the selector, a selector, a sorting separator and guide ducts for the coins, along with two “Hopper” type paying bins.

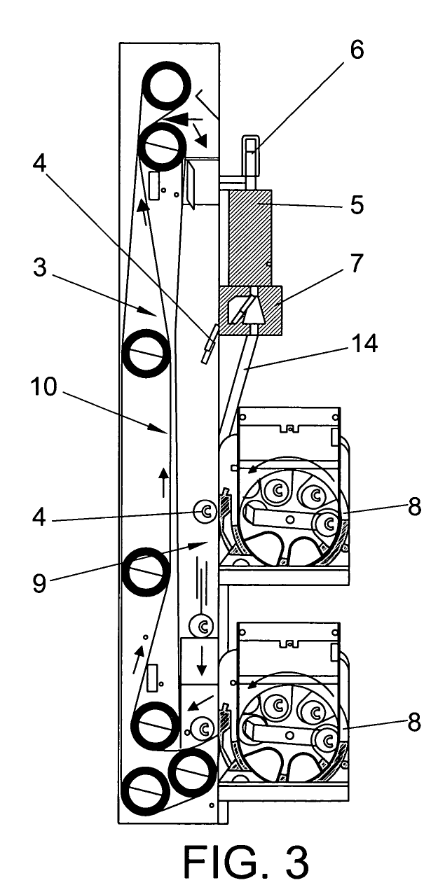

FIG. 3. Shows a view of the compact unit of FIG. 1 according to the cutting plane A-A, being able to observe the conveying means for the coins to the collection box, along with the duct for the coins to fall from the “Hopper” type paying bins to the means of conveying the coins to the collection box.

### DESCRIPTION OF A PREFERRED EMBODIMENT

In view of the said figures and in accordance with the numbering adopted, we can observe how the compact unit 1 comprises a support casing 2 inside of which are fitted the conveying means 3 for coins 4 destined for return and payment, this casing 2 being associated and fitted with the remaining elements for the automatic validation and handling of the coins.

So, fitted in the support casing 2 there is a selector 5 for the validation of the coins 4, this selector 5 being accessed via an entrance duct 6, beneath the selector 5 being fitted a sorting separator 7 for coins validated as “good”, in such a way that by means of that sorting separator, due to having different exits, the coins will be distributed for being ducted to the place of destination depending on needs.

Likewise, fitted in the support casing 2 there is a pair of “Hopper” type paying bins 8, the exit mouth for the coins from the corresponding paying bin 8 being connected to a duct 9 made in the interior of the actual support casing 2, this duct 9 leading to the conveying means 3 for coins to return/pay which will convey them to the collection box. Naturally, the compact unit 1 may have a variable number of “Hopper” type paying bins.

The conveying means 3 for coins to return/pay are defined by a pair of belts 10, duly guided, which are driven by means of a reducer motor 11, the rotation of them being controlled by a sensor of rotation 12 in such a way that both the reducer motor 11 and the sensor of rotation for the belts 10 are likewise fitted to the support casing 2.

In this way, the coins 4 introduced into the corresponding automatic machine, preferably a recreational prize machine willgain access to the selector 5, via the duct 6, for their validation and later passage to the sorting separator 7 for those coins validated as “good”, so that, depending on the validation made and on needs, the coins 4 are led to the place of destination.

On the other hand, if a coin is validated as “not valid”, having to be rejected, it will be led from the actual validation selector 5 to the duct 9 made in the interior of the actual casing 2 so that, with the operation of the conveying means 3 it will be conveyed towards the collection box. In this way, the pair of belts 10 receive the rejected coin and elevate it towards the duct 13 leading to the collection box.

In FIG. 3 of the designs it can be seen how the coins 4 validated as “not valid” are led from the actual selector 5 to the duct 9 made in the interior of the actual casing 2 in order to be received by the pair of belts 10 which will convey them by elevating them towards the duct 13 leading to the collection box.

On the other hand, coins validated as “valid” or “good” will be able to be destined for payment of prizes or be gathered in a deposit, in such a way that, depending on this, they will have to follow the corresponding path and so, if the coins are destined for payment of prizes, according to the number of paying bins 8 the unit incorporates, the coins will follow one path or another towards the respective paying bin, while the coins to be gathered in the deposit will be led to it by the duct 14, being able to observe in FIG. 1 of the designs how the duct 14 leads to the corresponding deposit via the lower part of the casing 2.

According to the practical embodiment represented in the attached figures in which the compact unit 1 incorporates two “Hopper” type paying bins 8 for coins destined for payment of prizes, it can be observed how, leading from the sorting separator 7, there are two ducts 15 and 16 which end in the respective paying bins 8, in such a way that the coins will follow one path or the other depending on whether they have to be led to one of the paying “Hopper”s 8 or the other.

Naturally, the number of “Hopper” type paying bins 8 incorporated into the compact unit will be variable depending on needs.

In FIG. 3 of the designs it can be seen how, in order to pay the prizes, the corresponding coins 4 will be led from the “Hopper” type paying bin 8 to the duct 9 in order to be received by the pair of belts 10 and be conveyed, elevating them towards the duct 13 which ends in the collection box.

1. COMPACT UNIT FOR MEANS OF VALIDATION AND PAYMENT/RETURN OF COINS, such that said compact unit is of utility for its incorporation in automatic dispensing machines and especially in recreational prize machines, wherein the compact unit comprises a support casing inside of which are fitted conveying means for coins destined for return and payments, associated with said casing is a selector to which the coins gain access via an inlet duct, a coin sorting separator beneath the selector, at least one “Hopper” type paying bin, the exit mouth for the coins from the paying bin being connected to a duct made in the interior of the support casing, this duct leading to the conveying means the coins to be returned/paid which will convey them to the collection box, along with a series of guide ducts for the coins:

2. COMPACT UNIT FOR MEANS OF VALIDATION AND PAYMENT/RETURN OF COINS, according to claim 1, wherein the support casing is fitted with a reducer motor for driving the conveying means and a sensor of rotation, the conveying means for coins being defined by a pair of belts duly guided.

3. COMPACT UNIT FOR MEANS OF VALIDATION AND PAYMENT/RETURN OF COINS, according to claim 1, wherein the coins rejected by the selector from the actual selector are led to the duct made in the interior of the support casing, this duct leading to the conveying means the coins to be returned/paid which will convey them to the collection box.

4. COMPACT UNIT FOR MEANS OF VALIDATION AND PAYMENT/RETURN OF COINS, according to claim 1, wherein the coins validated by the selector as acceptable can be led from the corresponding outlet of the sorting separator via respective ducts, to the different “Hopper” type paying bins.

5. COMPACT UNIT FOR MEANS OF VALIDATION AND PAYMENT/RETURN OF COINS, according to claim 1, wherein the coins validated by the selector as acceptable can be led from the corresponding outlet of the sorting separator via the respective duct, to the storage deposit.
